(19) United States
(12) Patent Application Publication
(10) Pub. No.: US 2008/0315676 A1
(43) Pub. Date: Dec. 25, 2008

(54) WHEEL RIM COMPONENTS, RIMS, WHEELS, WHEELED APPARATUS, AND METHODS OF MAKING AND USING SUCH

(76) Inventor: John Cobb, Tyler, TX (US)

Correspondence Address: GILBRETH & ASSOCIATES, P.C., PO BOX 2428, BELLAIRE, TX, 77402-2428, US

(21) Appl. No.: 12/054,354

(22) Filed: Mar. 24, 2008

Related U.S. Application Data
(60) Provisional application No. 60/896,488, filed on Mar. 22, 2007.

(51) Int. Cl. B60B 5/02

(52) U.S. Cl. 301/95.102; 29/894

(57) ABSTRACT

A wheel having a tire receiving ring and a fiber reinforced plastic rim. The ring has a ring outer annular surface, and a ring inner annular surface, wherein the ring inner annular surface defines a material opening. The fiber reinforced plastic rim has a rim outer annular surface. The ring inner annular surface and rim outer annular surface are abutted together.

### RELATED APPLICATION DATA

This application claims priority of U.S. Provisional Patent Application Ser. No. 60/896,488, filed Mar. 22, 2007, which application is incorporated herein by reference.

### BACKGROUND OF THE INVENTION

1. Field of the Invention

The present invention relates to rims for wheels, to rim components, to wheels and apparatus, and to methods of making and using such rims, components, wheels, and apparatus. In another aspect, the present invention relates to rims for bicycle wheels, to rim components, to wheels and wheeled apparatus, and to methods of making and using such rims, components, wheels and apparatus. In even another aspect, the present invention relates to polymeric containing rims for wheels, to rim components, to wheels and apparatus, and to methods of making and using such rims, components, wheels, and apparatus.

2. Description of the Related Art

Bicycle wheels and rims therefor have been in use for well over a century. From most of the bicycle era, bicycle rims have been made of metal, most commonly, steel or aluminum. However, in the past few decades, some bicycle rim manufacturers have begun to produce bicycle rims from other materials, such as composite materials.

A composite material is a combination of two materials that has its own distinctive structural properties. A common type of composite comprises a fiber reinforcing material within a polymeric matrix (i.e., fiber reinforced plastic or FRP). The reinforcing material is generally a short or long fiber, which may be in the form of filaments or woven into larger strands or cloth, with such fibers comprising metal, natural or synthetic materials. The polymeric matrix may be any suitable thermoplastic or thermoset material as desired. As a non-limiting example, an FRP, may be formed using filaments or woven cloth of fiber glass embedded in a polyester or epoxy resin base. Fiber glass reinforced plastic composites may lack the stiffness of other polymer fiber filaments such as aramid fibers such as the commercially available KEVLAR®, or polyolefin fibers, such as SPECTRA® polyethylene fibers, carbon, ceramic and boron to name a few. Composites made from such relatively high strength reinforcing polymeric fibers are generally known within the industry as advanced composites.

The initial use of advanced composites was mainly for high technology military and aerospace applications. However, in recent years advanced composites have been used outside these areas and their use is now common in many consumer areas such as the automotive and sports industries.

As might be expected, bicycle wheels have been made from FRPs, including carbon fiber, fiberglass, and nylon fibers, mixed in a resin such as epoxy-based resins, phenolic-based resins and/or ester-based resins. Of these composite rims, some have been comprised entirely of FRP composite materials (“full composite wheels”), whereas others have incorporated components of different materials in addition to FRP composites (“multi-component rims”).

There are numerous commercially available examples of bicycle wheel rims made entirely of a composite material, as well as patents disclosing such, the following of which are hereby incorporated by reference.

U.S. Pat. No. 4,983,430, issued Jan. 8, 1991, to Sargent, discloses a composite wheel rim and method of making such.

U.S. Pat. No. 5,061,013, issued Oct. 29, 1991, to Hed et al., discloses an example of a full carbon fiber composite rim.

Although full composite wheels represent the current state-of-the-art in high-tech bicycle rims because of their strength, weight and aerodynamic efficient profiles, bicycle rims made entirely of FRP composites are not well suited to all uses. In particular, one drawback with known full composite bicycle rims, is that it is difficult to form a full FRP composite fiber rim that will accept standard beaded bicycle tires. Rather, most full FRP composite wheels are designed for use with “sew up” tires that are actually glued to the rim.

To overcome the limitations of full FRP composite rims, multi component rims have been produced that contain both an FRP composite component and a metallic component.

U.S. Pat. No. 5,080,444, issued Jan. 14, 1992, to Hopkins et al., discloses a wheel formed of a rim joined to a hub by a multi-spoke foam structure that is coated with a fiber reinforced resin material is defined by particular relationships between the spokes and the radiused sections joining the spokes to the hub and the rim.

U.S. Pat. No. 5,975,645, issued Nov. 2, 1999, to Sargent, discloses a two piece rim having a carbon fiber based body portion having bulbous sidewalls capable of flexing in response to radially directed forces, and a tire engaging, hoop-like rim made from aluminum.

U.S. Pat. No. 6,991,298, issued Jan. 31, 2006, to Ording et al., discloses a fiber resin plastic (FRP) based bicycle rim that includes an FRP body and a metal tire receiving ring.

### SUMMARY OF THE INVENTION

According to one non-limiting embodiment of the present invention, there is provided a wheel. The wheel includes a tire receiving ring having a ring outer annular surface, and a ring inner annular surface. The ring inner annular surface defines a material opening. The wheel also includes a fiber reinforced plastic rim having a rim outer annular surface. The ring inner annular surface and rim outer annular surface are abutted together.

According to another non-limiting embodiment of the present invention, there is provided a method of making a wheel. The method includes abuting a tire receiving ring and a fiber reinforced plastic rim. The tire receiving ring has a ring outer annular surface, and a ring inner annular surface, wherein the ring inner annular surface defines a material opening. The fiber reinforced plastic rim has a rim outer annular surface. They are abutted together in such a manner that the ring inner annular surface and rim outer annular surface are abutted together to form an abutted wheel.

According to even another non-limiting embodiment of the present invention, there is provided a method of making a wheel precursor. The method includes weaving a retaining material through a plurality of material retaining openings. These retainer openings are on the tire receiving ring, and are defined by a ring outer annular surface, and a ring inner annular surface of the tire receiving ring. The retaining material is woven into contact with the ring outer annular surface and the ring inner annular surface.

According to still another embodiment of the present invention, there is provided a method of making a wheel. The method includes weaving a retaining material through a plurality of material retaining openings, wherein the retainer openings are defined by a ring outer annular surface, and a ring inner annular surface of a tire receiving ring. The retaining material is woven into contact with the ring outer annular surface and the ring inner annular surface. The method also includes assembling together the tire receiving ring and a fiber reinforced plastic rim having a rim outer annular surface, in such a manner that the ring inner annular surface and rim outer annular surface are abutted together to form an abutted wheel.

### BRIEF DESCRIPTION OF THE DRAWINGS

In the drawings, like reference numbers between the drawings, refer to like elements.

FIG. 1 shows a fiber reinforced plastic (FRP) based bicycle rim 10 of the present invention, being comprised of two primary components, a carbon fiber body 12, that is circumferentially surrounded by a tire receiving ring 14.

FIG. 2 shows a partial section of rim 10 of FIG. 1, further showing hub 36, and spoke 34 connecting rim 10 with hub 34.

FIG. 3 shows a cross-sectional view of wheel 10.

FIG. 4 is an exploded cross-sectional view of wheel 10, showing carbon fiber body 12, a tire receiving ring 14, and retaining member 205.

FIG. 5 is an isometric sectional view of wheel 10, showing carbon fiber body 12, tire receiving ring 14, with retaining member 205 removed from retaining passage 201.

FIG. 6 is a section of tire receiving rim 14, showing material opening 201

FIG. 7 is a section of tire receiving rim 14, showing a strip of material woven through passages 201.

FIG. 8 is a section of tire receiving rim 14, showing material positioned in passages 201.

FIG. 9 is a section of tire receiving rim 14, showing a strip of material on top of passages 201.

FIG. 10 is a section of tire receiving rim 14, showing non-limiting examples of suitable passages 201.

FIG. 11 is a view of ring 14 having ends 70 and 72.

FIG. 12 is an enlarged view of a portion of ring 14 of FIG. 11, with ends 70 and 72 abutted.

FIG. 13 is a partial view of ring 14, showing a non-limiting embodiment of passage 201.

FIG. 14 is a partial view of ring 14, showing a non-limiting embodiment of passage 201.

### DETAILED DESCRIPTION

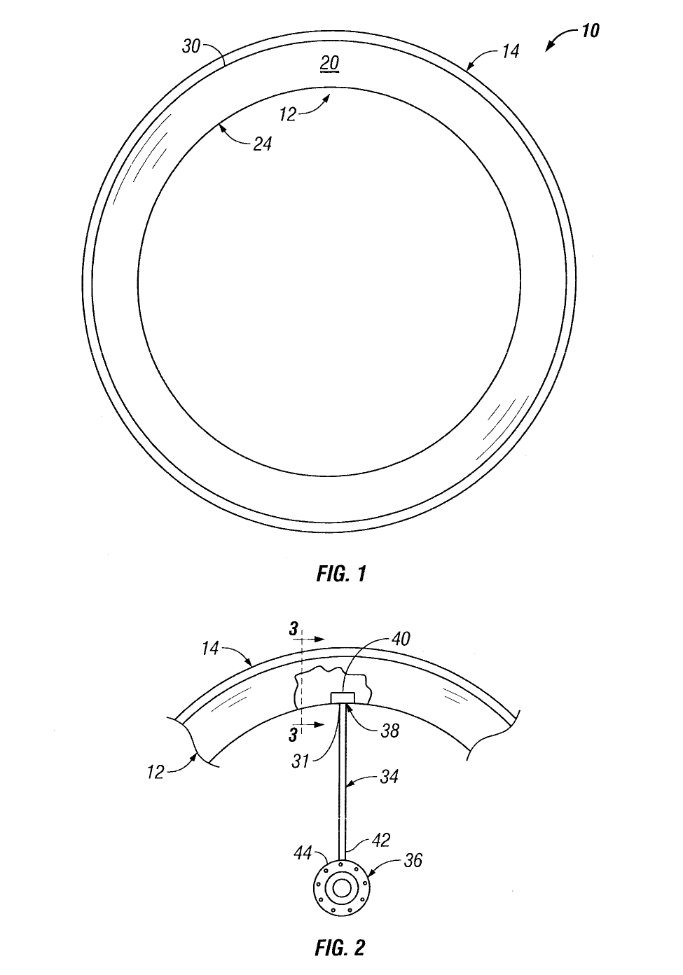

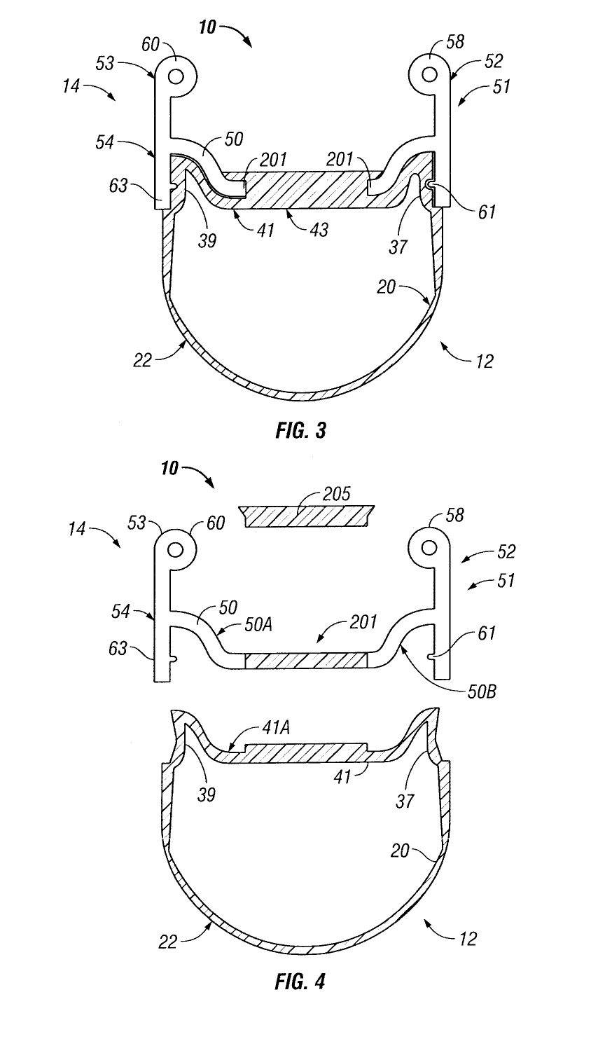

Referring now to FIG. 1, there is shown a fiber reinforced plastic (FRP) based bicycle rim 10 of the present invention, being comprised of two primary components, a carbon fiber rim 12 having a sidewall 20 and 22 (see FIG. 3), that is circumferentially surrounded by a tire receiving ring 14.

FIG. 2 shows a partial section of rim 10 of FIG. 1, further showing hub 36, and spoke 34 connecting rim 10 with hub 34. In further non-limiting detail, the FRP bicycle rim 10 of the present invention may be designed for use with spokes 34 for connecting rim 10 to wheel hub 36 containing an axle (not shown) that is coupled to a frame member, a non-limiting example is which include a fork (not shown) of a wheeled apparatus, a non-limiting example of which includes a bicycle or other vehicle (not shown).

Spokes 34 and spoke coupler 40 are well known in the wheel art, and any suitable spoke and spoke coupler may be utilized. Spokes 34 include a first end 31 that is received by a spoke receiving port 38. An axially adjustable coupler 40 may receive first end 31 of spoke 34 for securing spoke 34 to FRP body 12, and for providing a tensioning mechanism for exerting an appropriate tension on spoke 34. This coupler 40 may be similar to a nut for a bolt, and may be positioned against, anchored to, and/or incorporated into FRP rim 12 in any suitable manner. The second end 42 of the spoke engages a hub aperture 44.

In some embodiments, FRP rim 10 of the present invention is designed so that spoke 34 can be supportively coupled to it. By “supportively coupled” it is meant that the forces that are exerted by spoke 34 on rim 10 are exerted on FRP rim 12 itself, rather than on tire receiving ring 14, or any other component of rim 10. FRP rim 12 and spoke receiving port 38 may be sized, configured, and designed for absorbing these force loads, so as to obviate the need for other force-absorbing components to be added to the rim.

Alternatively, spoke first end 31 may be secured to base portion 50 (see, FIG. 3), rather than FRP body 12.

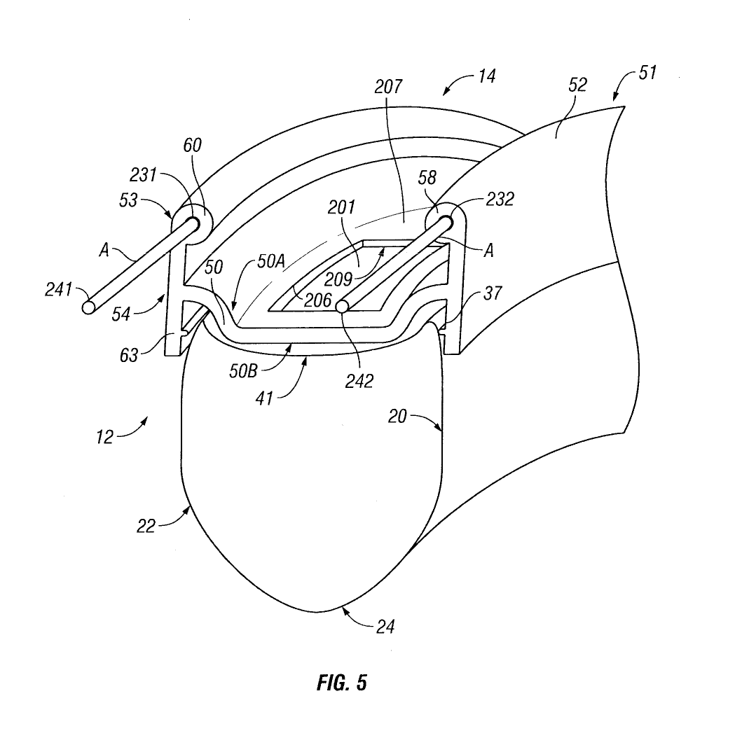

Referring now to FIG. 3, there is shown a cross-sectional view of wheel 10. Additionally referring to FIG. 4, there is shown an exploded cross-sectional view of wheel 10, showing carbon fiber body 12, a tire receiving ring 14, and retaining member 205, and to FIG. 5, there is shown an isometric sectional view of wheel 10, showing carbon fiber body 12, tire receiving ring 14, with retaining member 205 removed from retaining passage 201.

Tire receiving ring 14 is generally H-shaped in cross-section with the “H” formed by first braking member 51 (which forms the first upright leg of the H), second braking member 53 (which formed the second upright leg of the H), and FRP body engaging base portion 50 (which forms the crossbar of the H). Ring portion 50 comprises an outer annular surface 50A, and an inner annular surface 50B. It is ring inner annular surface 50B that abuts with and engages rim outer annular surface 41A.

First braking member 51 includes an axially outwardly facing first braking surface 52, a radially inwardly extending lower leg portion 61, that extends generally perpendicularly to FRP body engaging base portion 50 of the tire engaging ring 14, and is disposed adjacent to one edge of the FRP body engaging base portion 50.

Second braking member 53 includes an axially outwardly facing second braking surface 54, and a radially inwardly extending lower leg portion 63, and extends in a plane generally parallel to the first braking member 51 and braking surface 52, and is disposed at the opposite edge of the axially extending base portion 50.

The axially outwardly facing first and second braking surfaces 52, 54 comprise the actual brake engaging surfaces that the bicycle brake engages in order to increase the frictional resistance between the brake and the rim 10, to thereby stop the rotation of the bicycle wheel, and hence, stop the bicycle. As best shown in FIG. 3, a first bead 58 is disposed at the distal end of the first braking surface 52, and a second bead 60 is disposed at the distal end of the second braking surface 54. The first and second beads 58, 60 are provided for engaging a corresponding bead of the conventional bead-type tire to thereby form a mechanical interlock between the beads 58, 60 of the tire receiving ring 14, and the beads of the tire (not shown) which is held in engagement largely through the air pressure within the tire.

Depending upon how ring 14 is assembled, braking surfaces 52, 54 may or may not be continuous, seamless braking surfaces about their entire area, and may or may not contain gaps or discontinuities in any portions of the first and second braking surfaces 52, 54.

FRP body engaging portion 50 may be any suitable shape for engaging upper end portions 37 and 39 and the annular outer edge 41 of FRP body 12. Generally, ring annular surface 50B and rim outer annular surface 41A will be made complimentary to some degree to encourage adhesion. Further, surface SOB and surface 41B, may be made lockingly engageable.

As shown in FIG. 5, FRP body engaging portion 50 further defines one or more material retaining openings 201, which in the embodiment as shown are passages.

As shown in FIG. 4, a retaining member 205 within passage 201 will secure carbon fiber rim 12 to tire receiving ring 14. In general, the idea is that during curing of carbon fiber rim 12 to tire receiving ring 14, carbon fiber rim 12 may be joined to ring 14 by being consolidated to retaining member 205 adhered within passage 201. Rim 12 may be provided with one or more protrusions 253 which are positioned to extend into passages 201, when rim 12 and ring 14 are joined together. As a non-limiting example, a series of protrusions 253 may be provided which align with and extend into a series of passages 201. Geometries of the protrusions 253 and passages 201 will be selected on a case-by-case basis to achieve engineering, performance, and economic requirements. These protrusions may then form into retaining member 205 and/or be adhered to or integral with rim 12.

Retaining member 205 may be adhered to rim 12 by an adhesive substance, or during heating/curing retaining member 205 and rim 12 may soften and become affixed together, or during heating/curing retaining member 205 and rim 12 may flow together and become integrally connected, or during heating/curing material from rim 12 may flow into passage 201 and form retaining member 205.

In other words, retaining member 205 may be a separate member that is adhered to or consolidated into rim 12, or retaining member 205 may be formed during heating/consolidation out of separate material and then adhered to or consolidated into rim 12, or retaining member 205 may be formed from material from rim 12 and be integral to rim 12. It should be understood that whether the retaining member is adhered to or consolidated to the rim, it is considered to be “connected” to the rim, as opposed to merely abutted to the rim.

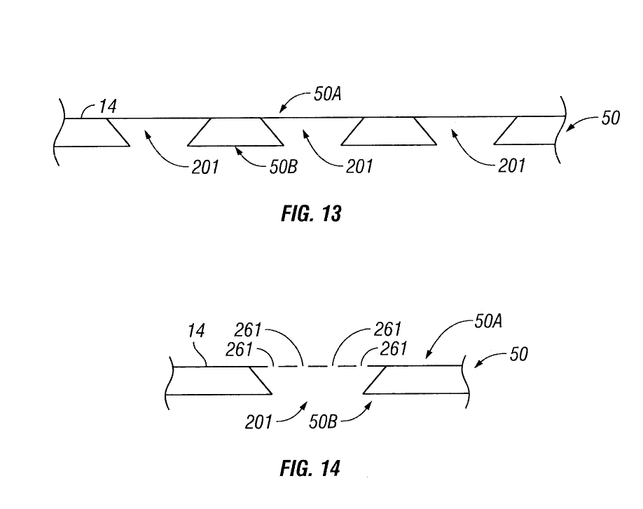

Referring now to FIGS. 13 and 14, there are shown partial views of ring 14 with other non-limiting embodiments of material openings 201. Specifically, in FIG. 13, material opening 201 is actually a cavity, and is defined by ring inner annular surface 50B. Certainly, material may have difficulty flowing into or being forced into cavity 201 of FIG. 13, as the specter of air bubbles/pockets may impede material flow. A solution would be to provide riser holes or vent holes 261 in ring outer annular surface 50A as shown in FIG. 14. Any air bubbles or pockets could be forced out through riser/vent holes 261 and allow easier flow of material into cavity 201. The shape of cavity 201 will function to form a wedge of material once it is consolidated, to provide more holding strength.

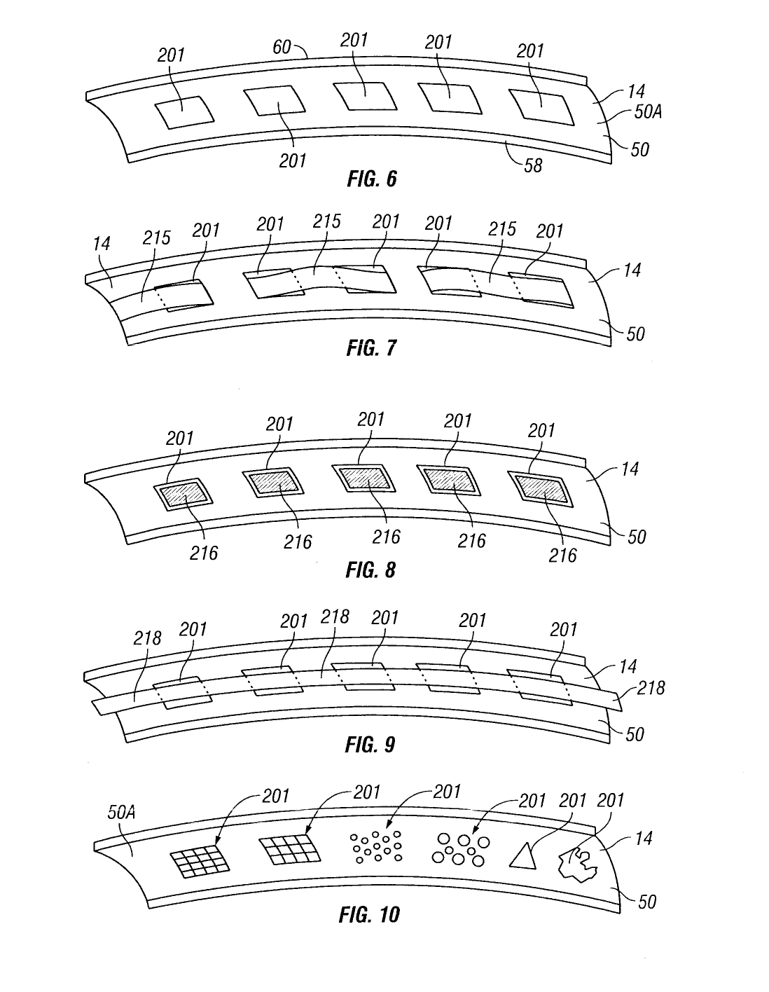

Referring now to FIGS. 6-9, there are a number of other suitable ways for providing additional material to form retaining member 205. FIG. 6 shows a section of ring 14 having a plurality of passages 201.

In one embodiment, polymeric material from the carbon fiber rim 12 will flow into passages 201 and form into retaining member 205 during curing. In other words, no material needs to be added other than to provide carbon fiber rim 12. Of course, making member 41 of carbon fiber rim 12 thicker may provide additional material for flow into passage 201.

In another embodiment, additional polymeric material may be added on top of member 41 of rim 12, prior to assembly of rim 12 with ring 14. This added polymeric material may be in solid and/or liquid form. This added material may be in the form of components that will form into a polymeric material (i. e, polymer and curing agent, or polymer and crosslinking agent, etc). This added polymeric material may be in the form of granules, particles, beads, strips, and the like. This added material may be in the form of protrusions as discussed, this added material may be in the form of a thickened member 41. Again, during curing, this added material will flow into passage 201 and form retaining member 205 and adhere rim 12 with ring 14.

In even another embodiment, there is shown in FIG. 7, a section of tire receiving rim 14, showing a strip of polymeric material 215 woven through passages 201. Most conveniently, strip 215 will be woven through passages 201 prior to assembly of rim 12 and ring 14, although it is certainly possible (but perhaps more difficult) to weave strip 215 through passages 201 after assembly. This embodiment provides added material in passage 201, on top of ring 14, and under ring 14. During curing, some of the material under ring 14 and on top of ring 14 may flow into passage 201, and this added material will form into retaining member 205.

In still another embodiment, there is shown in FIG. 8 a section of tire receiving rim 14, showing material 216 positioned in passages 201. This material 216 may be shaped to mate with passage 201, or may be somewhat smaller than the cross-sectional area of passage 201. This material may be sized to overlap passage 201. Depending upon the size of material 216, it may be added before or after assembly of rim 12 and ring 14.

In yet another embodiment, there is shown in FIG. 9 a section of tire receiving rim 14, showing a strip of material 218 on top of passages 201. This embodiment provides added material in passage 201, and on top of ring 14. During curing, some of the material on top of ring 14 may flow into passage 201, and this added material will form into retaining member 205.

In even still another embodiment, the methods as described above may be combined in any manner. For example, strip 218 as shown in FIG. 9 may be used on top of the woven strip 215 of FIG. 7, or on top of the materials 216 of FIG. 8, or even in addition to adding materials to member 41. Once assembled, any of these embodiments as shown in FIGS. 6-9 will provide a precursor wheel component.

Although retaining passage 201 has been shown as having a rectangular shape, it should be understood that any suitable regular or irregular geometric shape may be utilized. The shape, number, and location of passages 201 will be selected to meet engineering, performance, and economic requirements.

It should also be understood that passage 201 may be in the form of a grid or screen to provide a more secure adhesive geometry for the polymeric material. Alternatives includes patterns of larger and smaller sized geometries, for example, a pattern of different sized circular holes. Non-limiting examples are shown in FIG. 10.

It should also be understood that any surfaces of tire receiving ring 14, especially those in passage 201, may be treated to provide improved adhesion between ring 14 and the polymeric material. Such treatment includes surface treatments, cleaning, coating to provide an adhesive surface, scoring, providing geometric protrusions/cavities for adhesion, and any combinations thereof. As a non-limiting example, surface 206 of passage 201, top surface 207 of ring 14, and/or the bottom surface 209 of ring 14, may be cleaned, roughened, scored, provided with protrusions, chemically treated, and/or chemically coated, all to provide better polymeric adhesion.

Any suitable polymeric material may be utilized as the added material. However, the polymeric material selected for the added material, should be selected for adhesion to both ring 14 and rim 12.

Tire receiving ring 14 is adapted for receiving the beads of a conventional tire. Tire receiving ring 14 may comprise any suitable material whether natural or synthetic. Non-limiting examples of material suitable for use for tire receiving ring 14 include but are not limited to, metals, ceramics, composites, thermoplastics, thermosets, wood, plant derived materials, and combinations thereof. Preferred materials for tire receiving ring 14 are metals and composites. The most preferred metals are strong, lightweight materials, such as aluminum, titanium, and their alloys.

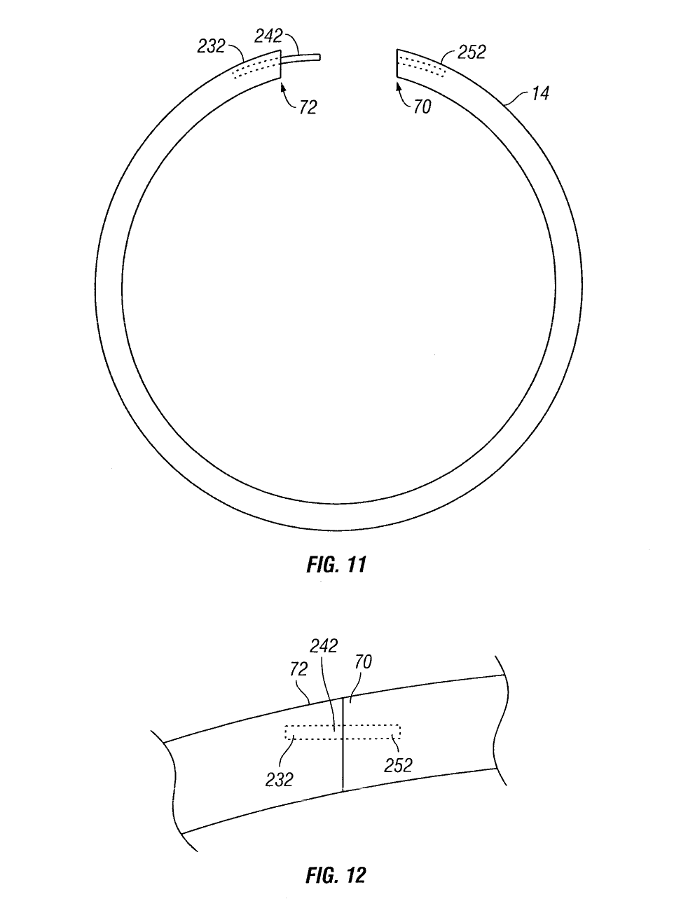

Referring now to FIGS. 11 and 12, the manufacture of the ring 14 will be described.

As is well known, a generally linear, metallic tire receiving member is cut to shape. The cross-sectional shape of tire receiving member 14 is best shown in FIGS. 3-5.

Although this embodiment is shown as using pins 241 and 242 to assemble ring 14, other assembly methods may be used. Passages 201 and pin passages 231 and 232 may be provided in member 14 at any convenient time in the manufacturing process.

After the generally linear tire receiving member is formed, and cut to a length generally equal to the circumferential length of the final hoop, the tire receiving member 14 is bent upon a mandrel or other tool to change it from its generally linear configuration to a generally circular hoop-like configuration shown in FIG. 1.

Turning now to FIG. 11 the ring 14 is shown in its hooped configuration, where its first end 70 is placed somewhat adjacent to its second end 72. Ends 70 and 72 may be joined together by any suitable method. For example, as shown in FIGS. 5, 11 and 12, ends 70 and 72 may be joined together with pins 241 and 242, with an adhesive, and/or with welding.

First end 70 may include a pin receiving passage 252, and second end 72 likewise may have a pin receiving passage 232. A joining pin 242 may be placed in either passage, and is shown in FIG. 11 positioned in passage 232.

Passages 232 and 252 may be somewhat limited in length and not connected, or may run throughout ring 14 and may in fact be one continuous passage.

Not shown in FIG. 11, but seen in FIG. 5, there is also a second pin 241 and additional passages 231 for pin 241.

After the ends, 70, 72 are placed adjacent each other, optional pins 242 and 241 are aligned in their particular passages. These pins 241 and 242 may serve the purpose of alignment and/or added strength. Pins 241 and 242 may be friction fit into their passages, may somehow fasten to their passages (for example by locking pins or rotation, and the like), and/or may be adhesively secured.

In addition to the use of pins 241 and 242, or even in combination therewith, the two ends 70 and 72 may be joined together through the use of a joinder material, such as a adhesive material and/or welding material, wherein the ends, especially the brake surface portions, are adhered/welded together. In the welding process, the metal, at the points to be joined, is melted. Additionally, a molten metal, (preferably molten aluminum for an aluminum ring 14) is added as a filler or joinder material, to form a brake surface joint on braking surfaces 52 and 54.

The two ends 70, 72 of the precursor un-joined hoop may be joined together by flash butt welding, wherein the joinder material comprises the material of the ends. To flash butt weld the ends together, the one or both ends are heated so that the aluminum at the ends is melted, or semi-molten. The one end is then pressed (butted) under pressure against the other end so that the molten aluminum of the two ends co-mingles. When the metal cools, the first and second ends are metallically joined to each other. Since flash-butt welding will usually not produce a smooth joint, finishing, such as by machining, is usually still necessary before the wheel is ready for use.

The next step in the process of manufacturing the rim 14, is to treat the braking surfaces and weld joint so that the first and second brake surfaces form, respectively, first and second smooth, continuous braking surfaces, especially at the points where the first and second ends of the rim come together, which portion now comprises the area of the rim adjacent to the joint. As will be described in more detail below, this machining preferably occurs after the ring 14 is joined to the FRB body portion 12, after the joined ring 14 and rim 12 are removed from the mold.

During the machining process, the brake surfaces 52, 54 are ground and polished to allow a proper braking surface. In some instances, they are ground and polished so that the position of the joints (on each braking surface between ends 70 and 72) is not apparent to one viewing the brake surfaces 52, 54, so that the brake surfaces 52, 54 appear as smooth, continuous surfaces having no discontinuities in the areas of the joints. More important, the joints are preferably constructed so that no discontinuities are functionally apparent to a bicycle caliper brake that is engaging the brake surface 52, 54 during the application of the caliper to the brake surfaces 52, 54. This lack of discontinuities provides for a smooth, discontinuity-free braking surface of the rim.

Additionally, the strength of the joints and optional pins 241 and 242, maintains the respective positions of the braking surfaces in their co-planar, aligned position, not only in the time period shortly after the manufacture of the rim, but also during the useful life of the rim, as the joints/pins are preferably strong enough to maintain the respective positions of the brake surface and with respect to each other during the use and operation of the rim 10.

A non-limiting example of a process by which the rim 10 of the present invention is manufactured will be described.

As discussed above, a tire receiving ring is formed by first extruding the tire receiving member 14. The tire receiving member is then bent to form a hoop-like ring, with the ends 70, 72 of the ring abutting each other. The ends 70, 72 of the brake surfaces 52, 54 of the tire receiving member 14 are then welded together to form a continuous ring.

In a separate operation (which may occur before, after or during the making of ring member 14), FRP rim 10 is formed. The following discussion relates primarily to one non-limiting example for manufacturing carbon-fiber type FRP rims, it being understood that many variations may be utilized, and that some differences in the manufacturing process may exist if other FRPs are used.

FRP rim 12 may be formed by any suitable method. As a non-limiting example, it may be formed by laying up sheets of carbon fiber containing composite materials, in a mold. Carbon fiber rim 12 can be formed through the use of a dry fiber, to which resin is added. Also, it can be done through a pre-preg system, wherein the resin is already placed in the fiber before it is molded. Further, one can also perform resin transfer when bladder molding the carbon fiber body 12. Alternately, the FRP rim 12 can be injection molded with an injection moldable FRP such as nylon, polypropylene, polyethylene, with a glass fiber. A FRP glass fiber can be used in place of a carbon fiber. However, the use of a glass fiber would change the performance characteristics of the rim, although there would still be inherent sidewall flex when mated with the aluminum rim 12.

As discussed above, the more common procedure for producing the carbon fiber body is that sheets of uncured carbon fiber material are laid up in a mold having the proper dimensions and shape. In most cases, multi-layer carbon fiber wheel that utilizes different types of appropriately oriented carbon fiber materials tends to form the best and most structurally strong rim. When cured, rim 12 comprises a carbon fiber laminate having the desired stress and sheer resistance, and ability to flex and bend, and absorb stress, in the appropriate direction.

After the various carbon fiber resin layers are laid up in the mold, it is partially, but not fully cured. Typically, this partial curing occurs through the addition of heat and/or pressure within the mold.

It is now time to join rim 10 with ring 14. Thought must be give as to how material will flow into passages 201. Material will either be provided by rim 10 without adding additional material, or additional material will need to be provided as discussed above.

The partially cured rim body 10, is then joined to the tire receiving ring 14 which, as discussed above, has already been bent into a hoop, with its end joined. Preferably, this joinder of the ring 14 to the rim 12 takes place in the cavity of a mold that is designed to accommodate both the metal tire receiving ring 14 and the carbon fiber rim 12. As alluded to above, the tire receiving ring 14 and carbon fiber rim 12 are either joined together outside of a mold cavity, and then placed, together, within the mold cavity; or alternately, joined together within the mold cavity by placing the tire receiving ring 14 and carbon fiber rim 12 within the mold cavity.

The next step in the process is that the mold cavity is closed, and heat and pressure is applied to the joint tire receiving ring 14 and rim 12 to cure the carbon fiber rim 12 from its less than fully cured state, to its fully cured state. It is during this time that material will flow into passages 201 and consolidate rim 12 to ring 14.

Due to the fact that the carbon fiber rim 12 cures primarily through a chemical cure process, wherein the resin component (e.g. epoxy materials) contained with the carbon fibers cure, the temperature and pressure that is exerted within the mold need not be that great. Temperatures in the range of between 150 F and 500 F, and preferably in the range of between 250 F and 350 F are generally sufficient for most resin materials.

The finished rim can then be removed from the mold cavity after the carbon body rim is fully cured, and has cooled sufficiently so that the carbon fiber body rim 12 has had an opportunity to harden.

Next, the brake surfaces 52, 54 of the tire receiving ring 14 are machined to form continuous brake surfaces wherein each of the brake surfaces 52, 54 is generally co-planar throughout its circumference, wherein the brake surfaces 52, 54 are devoid of any discontinuities or gaps.

The wheel may be further subject to polishing or deburing as necessary. Additionally, the spoke receiving ports 24 can be formed within the inner annular edge of the carbon fiber rim 12 after the rim 10 is removed from the mold, in the case where such ports were not formed into the annular inner edge during the process of the carbon fiber body rim 12.

Through the process described above, the FRP body bicycle rim of the present invention can be produced.

The wheels of the present invention may be utilized for making wheeled apparatus, human powered as well as motorized. Non-limiting examples of such wheeled apparatus include but are not limited to unicycles, bicycles, tricycles, wheel chairs, carts, buggies, motorcycles, and automobiles.

The various patents cited herein are hereby incorporated by reference.

1. A wheel comprising:
a tire receiving ring having a ring outer annular surface, and a ring inner annular surface, wherein the ring inner annular surface defines a material opening; and
a fiber reinforced plastic rim having a rim outer annular surface;
wherein the ring inner annular surface and rim outer annular surface are abutted together.

2. The wheel of claim 1, further comprising retaining material positioned in the material opening.

3. The wheel of claim 2, wherein the retaining material is adhered to the rim.

4. The wheel of claim 2, wherein the retaining material is integral with the rim.

5. The wheel of claim 1, wherein the material opening is further defined by the ring outer annular surface.

6. The wheel of claim 5, further comprising retaining material positioned in the material opening.

7. The wheel of claim 6, wherein the retaining material is adhered to the rim.

8. The wheel of claim 6, wherein the retaining material is integral with the rim.

9. The wheel of claim 1, wherein the rim outer annular surface comprises at least one protrusion, with said protrusion positioned in the material opening.

10. A method of making a wheel comprising:
(A) Abutting together a tire receiving ring having a ring outer annular surface, and a ring inner annular surface, wherein the ring inner annular surface defines a material opening, and a fiber reinforced plastic rim having a rim outer annular surface, in such a manner that the ring inner annular surface and rim outer annular surface are abutted together to form an abutted wheel.

11. The method of claim 10, further comprising prior to step (A):
providing retaining material in the material opening.

12. The method of step 11, further comprising:
Heating the abutted wheel sufficient to connect the retaining material to the rim.

13. The method of claim 10, with a plurality of passages defined between the ring inner annular surface and the ring outer surface, further comprising prior to step (A):
Weaving the retaining material though the plurality of passages.

14. The method of step 13, further comprising:
Heating the abutted wheel sufficient to connect the retaining material to the rim.

15. A method of making a wheel precursor comprising:
(A) weaving a retaining material through a plurality of material retaining openings, wherein the retainer openings are defined by a ring outer annular surface, and a ring inner annular surface of a tire receiving ring, and wherein the retaining material is woven into contact with the ring outer annular surface and the ring inner annular surface.

16. The method of claim 15, further comprising:
(B) assembling together the tire receiving ring and a fiber reinforced plastic rim having a rim outer annular surface, in such a manner that the ring inner annular surface and rim outer annular surface are abutted together.

17. A method of making a wheel comprising:
(A) weaving a retaining material through a plurality of material retaining openings, wherein the retainer openings are defined by a ring outer annular surface, and a ring inner annular surface of a tire receiving ring, and wherein the retaining material is woven into contact with the ring outer annular surface and the ring inner annular surface;
(B) assembling together the tire receiving ring and a fiber reinforced plastic rim having a rim outer annular surface, in such a manner that the ring inner annular surface and rim outer annular surface are abutted together to form an abutted wheel.

18. The method of step 17, further comprising:
(C) Heating the abutted wheel sufficient to connect the retaining material to the rim.
